(19) United States
(12) Patent Application Publication
(10) Pub. No.: US 2009/0164804 A1
(43) Pub. Date: Jun. 25, 2009

(54) SECURED STORAGE DEVICE

(75) Inventors: EITAN MARDIKS, Ra'anana (IL); Yitzhak Pomerantz, Kfar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd., Kfar Saba (IL)

(21) Appl. No.: 11/964,023

(22) Filed: Dec. 25, 2007

(51) Int. Cl. G06F 12/14; H04L 9/00

(52) U.S. Cl. 713/193; 380/44

(57) ABSTRACT

A method of preventing unauthorized access to digital content includes obtaining from a trusted entity a public key of a public-private key pair, encrypting content being received by a storage device using the public key, and storing the encrypted content on the storage device. The public-private key pair includes the public key and a corresponding private key. The content is encrypted on the storage device using the public key so as to be decipherable using a corresponding private key. Access to the corresponding private key is restricted to the trusted entity alone and encrypted content may be decipherable by the trusted entity, only after an indication of authorization for use of the corresponding private key is provided to the trusted entity. Also provided is a method of controlling access to encrypted content that is stored on a storage device operating as a secure storage device.

### FIELD OF THE INVENTION

The present invention relates to methods and devices for preventing unauthorized access to digital content.

### BACKGROUND OF THE INVENTION

A secured storage device is a device for storing content in a secure manner. A user using a secured storage device for storing his/her desired content (either directly, via a network, and/or by assignment to an operator) is also authorized access to this content. In existing systems the secured device configuration is typically deemed to include both encryption means and decryption means.

However, there are legally-constrained situations in which there is a need to write information to a storage device in a way that is secured from unauthorized reading by any person. Some applications further dictate that content be stored on a storage device in a way that is even not accessible by the owner of the secured device (for example, if content be not maintained and/or documented by any person or party in an unsecured manner). In such cases, the only way for accessing the secured content may be by obtaining an authorization by a court or any other government entity.

It would be desirable for people who need to provide evidence (e.g. an alibi, an incrimination, a priority date, and other commercial evidence) to be able to store content while assuring that confidentiality and privacy of the stored content remains intact.

### SUMMARY OF THE INVENTION

In view of the prior art and the present needs, it would be desirable to have a method of preventing unauthorized access to digital content using a storage device, the storage device operative to encrypt content being received to the storage device using a public key that is provided thereto and to then store the encrypted content. The storage device may utilize real-time encryption methods of received content, where content being received to the storage device is encrypted using a public key that is provided by a trusted entity.

The only way for the encrypted content to become decipherable is by having this trusted entity use a private key that corresponds to the public key and that is kept secured by the trusted entity. In other words, access to the private key is restricted to the trusted entity alone. The trusted entity is trusted not to release the private key. The use of the private key to decrypt the encrypted content may only be performed by the trusted entity, and may only occur if the trusted entity is instructed to do so by receiving an indication of authorization for use of the private key.

A trusted entity may be at least one entity other than the owner, dealer, and/or manufacturer of a storage device. An “indication of authorization” may be an instruction that is sent to the trusted entity from an authorized entity, such as a legal or government entity (conditional on a court order for example), to allow the trusted entity to use the private key for decrypting the encrypted content.

The storage device is authorized as a secured, “one-way”, storage device that is operative to encrypt content, but not to decrypt the encrypted content. The storage device is used in a host, such as a computing device (e.g. Personal Computer) and/or a communication device (e.g. mobile phone). Having the private key securely kept by a trusted entity may have the advantage that no party (not the user, not the manufacturer or dealer of the storage device, and not the trusted entity) will be able to make any use of the stored content without an indication of authorization. The existence of a storage device that can be purchased off the shelf and used as a secured storage device that is authorized by a trusted entity without the need of the user to deal with encryption is of a great advantage.

In one embodiment of the foregoing approach, a method of preventing unauthorized access to digital content includes obtaining from a trusted entity a public key of a public-private key pair; encrypting content being received to a storage device, using the public key; and storing the encrypted content on the storage device. The content is being encrypted using the public key so as to be decipherable only using a corresponding private key of the public-private key pair. It should be noted that the encryption of content is being performed by the storage device and is transparent to the user. Access to the corresponding private key is restricted to a trusted entity only, and the encrypted content may become decipherable, by the trusted entity, only after an indication of authorization for use of the corresponding private key is being provided to the trusted entity.

The method may also include authenticating the storage device as a secured storage device. This may be performed by a certificate authority being a third-party organization that issues digital certificates used to create digital signatures and other security services, independently of the owner or the manufacturer of the storage device.

The method may also include obtaining from a plurality of trusted entities a plurality of public keys of a plurality of corresponding public-private key pairs, to thereby enable the encrypted content to become decipherable, by any of the plurality of trusted entities, only after an indication of authorization for use is provided thereto.

In another embodiment of the foregoing approach, a method for controlling access to encrypted content that is stored on a storage device includes generating a public-private key pair having a public key and a corresponding private key, by a trusted entity; and providing the public key while restricting access of the corresponding private key to the trusted entity only. The public key may be used by the storage device for encrypting content, such that the encrypted content is stored on the storage device. The encrypted content may be decrypted by the trusted entity only upon an indication of authorization for use of the corresponding private key is being provided to the trusted entity.

The public key may also be used by a plurality of storage devices; and the method may also include receiving the encrypted content, by the trusted entity, and decrypting the encrypted content, by the trusted entity only upon receiving the indication for authorization that is provided thereto.

In another embodiment of the foregoing approach, a storage device that includes an encryption unit operative to encrypt content using a public key of a public-private key pair; and a non-volatile memory operative to store the encrypted content. As noted above, the encryption of content is being performed by the storage device and is transparent to the user. The non-volatile memory may be a flash memory. The content is being encrypted so as to be decipherable only using a corresponding private key of the public-private key pair. Access to the corresponding private key is restricted to a trusted entity only, and the encrypted content may be decipherable, by the trusted entity, only after an indication of authorization for use of the corresponding private key is provided to the trusted entity.

Content being received to the storage device may be encrypted with a symmetric key; the symmetric key may be automatically generated by the storage device. By “symmetric key”, it is referred herein to a key that is used to both encrypt a file or message and also to decrypt the file or message. The symmetric key may then be encrypted with the public key so as to become decipherable, by the trusted entity alone, using a corresponding private key. The deciphering of the symmetric key may be performed only after an indication of authorization for use is provided to the trusted entity. Only then may the encrypted content be decipherable, by the trusted entity, using the deciphered symmetric key. In such case, the encrypted content is to be stored on the non-volatile memory with the encrypted symmetric key. In case a plurality of public keys are obtained from a plurality of corresponding trusted entities, the encrypted content may be stored on the non-volatile storage device with a plurality of symmetric keys, each of which is encrypted by a corresponding public key. The storage device may further include a unique identification that is operative to authorize the storage device as a secure, “one-way”, storage device.

In another embodiment of the foregoing approach, a trusted entity system has a computing unit operative to generate a public-private key pair having a public key and a corresponding private key; and a memory area operative to store the corresponding private key in a way that access to the corresponding private key is restricted to the trusted entity system alone. The public key may be used by a storage device for encrypting content, such that the encrypted content is stored on the storage device. The encrypted content may be decipherable, by the trusted entity alone, only after the indication for authorization is being received by the trusted entity thereto.

Additional features and advantages of the embodiments described are possible as will become apparent from the following drawings and description.

### BRIEF DESCRIPTION OF THE DRAWINGS

For a better understanding of the invention with regard to the various embodiments, reference is made to the accompanying drawings, in which like numerals designate corresponding sections or elements throughout, and in which:

FIG. 1 is a flow chart of a method of preventing unauthorized access to digital content, in accordance with an exemplary embodiment;

FIG. 2 is a flow chart of a method for controlling access to encrypted content that is stored on a storage device, in accordance with an exemplary embodiment;

FIG. 3 is a block diagram of a storage device for storing operating as a secure device, in accordance with an exemplary embodiment;

FIG. 4 is a block diagram of a storage device operating as a secure storage device, in accordance with another exemplary embodiment;

FIG. 5 is a block diagram of a storage device in communication with a host, in accordance with another exemplary embodiment;

FIG. 6 is a block diagram of a trusted entity system of a trusted entity, in accordance with an exemplary embodiment; and

FIG. 7 is a block diagram of a trusted entity system of a trusted entity, in accordance with another exemplary embodiment.

### DETAILED DESCRIPTION OF PREFERRED EMBODIMENTS

The embodiments and various aspects thereof will be better understood by referring to the present detailed description of exemplary and preferred embodiments. This description is not intended to limit the scope of claims but instead to provide examples of such embodiments. The following discussion therefore presents exemplary embodiments, which include a method of preventing unauthorized access to digital content, and a method of controlling access to encrypted content that is stored on a storage device. Also provided is a storage device that is implemented as a secure, “one-way”, storage device operative to encrypt content, but not to decrypt the encrypted content. It should be noted that the encryption of content is being performed by the storage device and is transparent to the user.

One embodiment of the method of preventing unauthorized access to digital content includes obtaining from a trusted entity a public key of a public-private key pair; encrypting content being received to a storage device using the public key; and storing the encrypted content on the storage device. The encrypted content stored on the storage device is being encrypted using the public key so as to be decipherable only using a corresponding private key of the public-private key pair. Access to the corresponding private key is restricted to a trusted entity only, and the encrypted content may become decipherable, by the trusted entity (and only by the trusted entity), only after an indication of authorization for use of the corresponding private key is being provided to the trusted entity.

Another embodiment of a method for controlling access to encrypted content that is stored on a storage device, includes generating a public-private key pair having a public key and a corresponding private key, by a trusted entity. The public key may be provided, while access to the corresponding private key is restricted to the trusted entity only. The public key may be then used by a storage device for encrypting content. The encrypted content is then stored on the storage device, and may become decipherable, by the trusted entity, only upon an indication of authorization for use of the corresponding private key is being provided to the trusted entity.

The storage device discussed herein may be compatible with any memory card format may, such as a secured digital (SD) memory card format used for storing digital media such as audio, video, or picture files. The storage device may also be compatible with a multi media card (MMC) memory card format, a compact flash (CF) memory card format, a flash PC (e.g., ATA Flash) memory card format, a smart-media memory card format, or with any other industry standard specifications. One supplier of these memory cards is SanDisk Corporation, assignee of this application.

The nonvolatile memory retains its memory or stored state even when power is removed. The storage device may also apply to other erasable programmable memory technologies, including but not-limited to electrically-erasable and programmable read-only memories (EEPROMs), EPROM, MRAM, FRAM ferroelectric, and magnetic memories. Note that the storage device configuration does not depend on the type of removable memory, and may be implemented with any type of memory, whether it being a flash memory or another type of memory. The storage device may also be implemented with a one-time programmable (OTP) memory chip and/or with a 3 dimensional memory chip technology.

Host systems with which such memory cards are used include cellular telephones, personal computers, notebook computers, hand held computing devices, cameras, audio reproducing devices, and other electronic devices requiring removable data storage. Flash EEPROM systems are also utilized as bulk mass storage embedded in host systems.

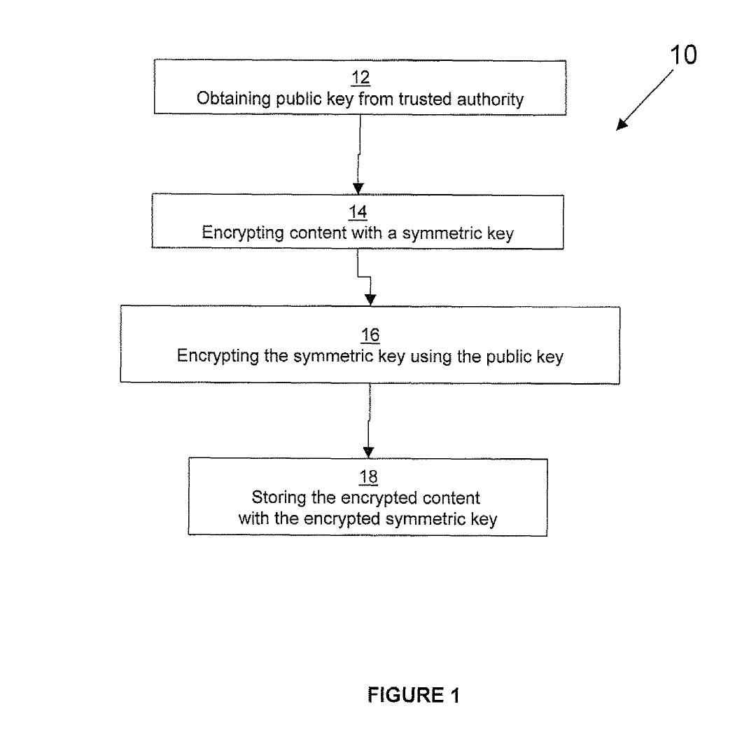

FIG. 1 is an exemplary flow chart of a method 10 of preventing unauthorized access to digital content using a storage device. In this example, the method may be performed by a manufacturer and/or dealer of the storage device, the manufacturer or dealer being a client or a user of a trusted entity. At 12 a public key of a public-private key pair is obtained from a trusted entity.

At 14, the content is encrypted with a symmetric key. The symmetric key, which is used to both encrypt a file or message and also to decrypt the file or message, may be typically automatically generated by the storage device at this phase.

Next, the symmetric key is encrypted, by the storage device, with the public key (16); and the encrypted content is then stored on the storage device, typically with the encrypted symmetric key (18). The content is being encrypted on the storage device using the public key so as to be decipherable only by using a corresponding private key of the public-private key pair. Access to the corresponding private key is restricted to the trusted entity alone, and the encrypted content on the storage device may be decipherable only after an indication of authorization for use of the corresponding private key is provided to the trusted entity.

The storage device may also be authorized as a secured device of the card manufacturer. For example, the storage device may be approved, stamped, labeled, marked and/or sealed (e.g. digital signature) by a card manufacturer as a secure, “one-way”, storage device that is operative to encrypt content but has no means to decrypt the encrypted content. The storage device may be used in a host, such as a computing device (e.g. Personal Computer) and/or a communication device (e.g. mobile phone).

Note that the storing of an encrypted symmetric key is not meant as a limitation; since it may further be applicable to store the encrypted content with the public key itself on the storage device, or to store an encrypted symmetric key on a storage area where the content is encrypted with the symmetric key. In case a plurality of public keys are obtained from a plurality of corresponding trusted entities, then the symmetric key may be encrypted a plurality of times, each time with a different public key; and the encrypted content (that may be previously encrypted with the symmetric key) may be stored on the storage device with the plurality of different encrypted symmetric keys.

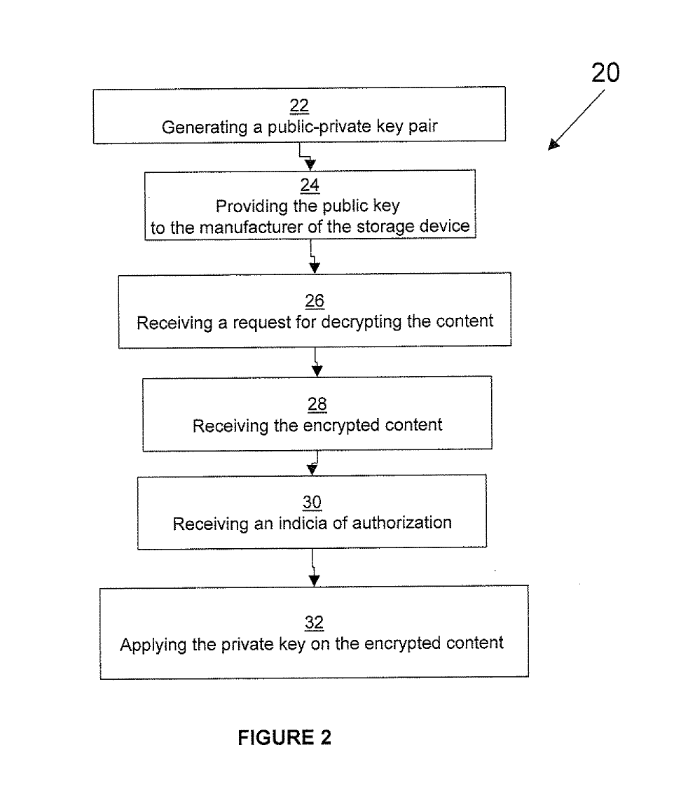

FIG. 2 is an exemplary flow chart of a method 20 for controlling access to encrypted content that is stored on a storage device. In this example, the method may be typically performed by a trusted entity providing services to a manufacturer of the storage device. The trusted entity may be at least one entity other than the owner, dealer, and/or manufacturer of the storage device.

At 22 a public-private key pair, having a public key and a corresponding private key, is generated by the trusted entity.

At 24 the public key is provided to a storage device or a storage device manufacturer. Note that access to the corresponding private key is restricted to, and may be used by, the trusted entity alone at all times. The public key that is provided by the storage device manufacturer is used by the storage device for storing encrypted content.

Next, the trusted entity receives a request (typically by a user of the storage device) for decrypting the content (26); and receives the encrypted content that is stored on the storage device (28). Only after an indication of authorization for applying the corresponding private key to the encrypted content is provided to the trusted entity (30), may apply the corresponding private key for decrypting its content (32). The decryption of the encrypted content may be performed by the trusted entity by first decrypting an encrypted symmetric key, being stored with the encrypted content, with the private key; and only then decrypting the encrypted content using the decrypted symmetric key.

As the corresponding private key may never leave the trusted entity, the encrypted content must be provided to the trusted entity in order for the encrypted content to be decipherable. Note that the encrypted content may be decipherable only upon the indication of authorization is provided to the trusted entity. The indication may be an instruction from an authorized entity, including a legal or government entity, to provide reading access to the encrypted content. As an example, the indication of authorization may be provided to the trusted entity under a court order.

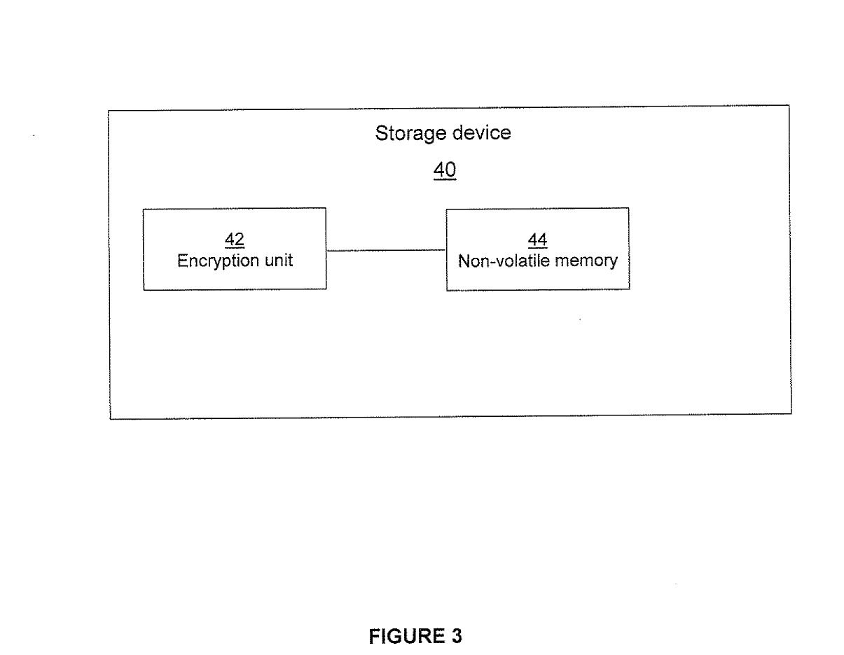

FIG. 3 is an exemplary block diagram of a storage device 40 operating as a secure storage device. As noted above, the storage device may be compatible with a Secured Digital (SD) memory card format, a Multi-Media Card (MMC) memory card format, a CompactFlash (CF) memory card format, or with any other memory card format.

An encryption unit 42 having a symmetric key (that may be automatically generated) is provided to encrypt content using a public key of a public-private key pair. Encryption unit 42 may be operative to encrypt content being received to the storage device 40 with the symmetric key; and then to encrypt the symmetric key with the public key. The content may further be encrypted in other ways using the public key. The encryption may be performed on-the-fly, while the content is being received to the storage device. The content is being encrypted so as to be decipherable, by a trusted entity, only using a corresponding private key (of the public-private key pair) that is accessible by and restricted to the trusted entity alone. As discussed herein above, the encryption of content is being performed by the storage device and is transparent to the user. Further as described above, access to the corresponding private key is restricted to the trusted entity alone; and the encrypted content stored on the storage device may be decipherable, by the trusted entity, only after an indication of authorization for use of the corresponding private key is provided to the trusted entity. The indication of authorization may be an instruction (e.g. in form of a court order) from an authorized entity, including a legal or government entity, to provide reading access to the encrypted content.

A non-volatile memory 44 is provided to store content which is encrypted using the public key. Non-volatile memory 44 may be a flash memory. The encrypted content may be stored on non-volatile memory 44 with the encrypted symmetric key. Note that encrypted content may also be stored on non-volatile memory 44 together with a plurality of different symmetric keys that are each encrypted with a public key of a different trusted entity.

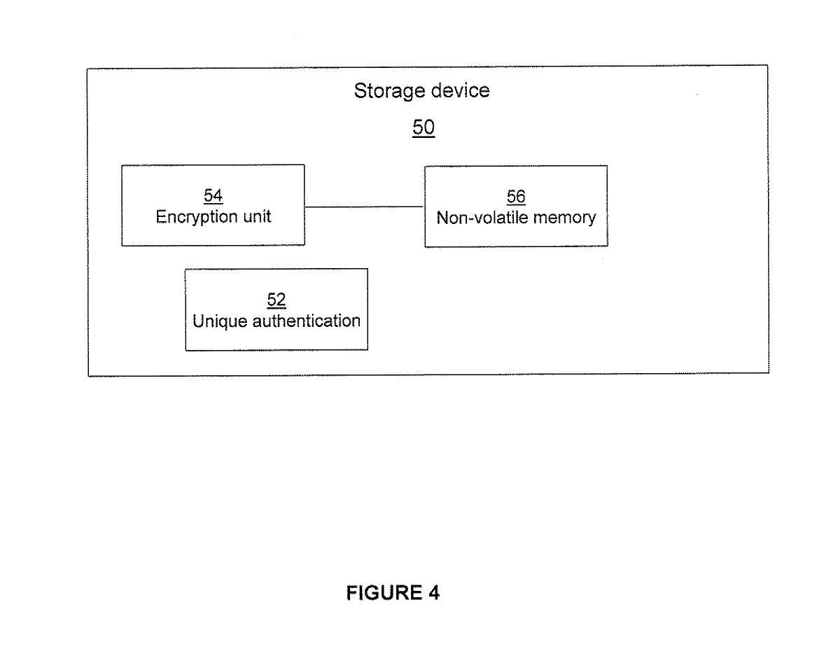

FIG. 4 is another exemplary block diagram of a storage device 50 operating as a secure storage device. In order to ensure that storage device 50 is a secure, “one-way” storage device that is operative to encrypt content but not to decrypt content, a unique authentication 52 may be provided. The unique authentication 52 may be any unique stamp, seal, mark, signal, label, approval and/or digital signature of the manufacturer of the storage device. The storage device may further be used with a host, such as a communication device or any type of computing device. Content that is received to storage device 50 is encrypted by an encryption unit 54 and then stored in an encrypted form (typically together with an encrypted symmetric key) on a non-volatile memory 56, encryption unit 54 and non-volatile memory 56 operative in a similar manner as their corresponding components of FIG. 3.

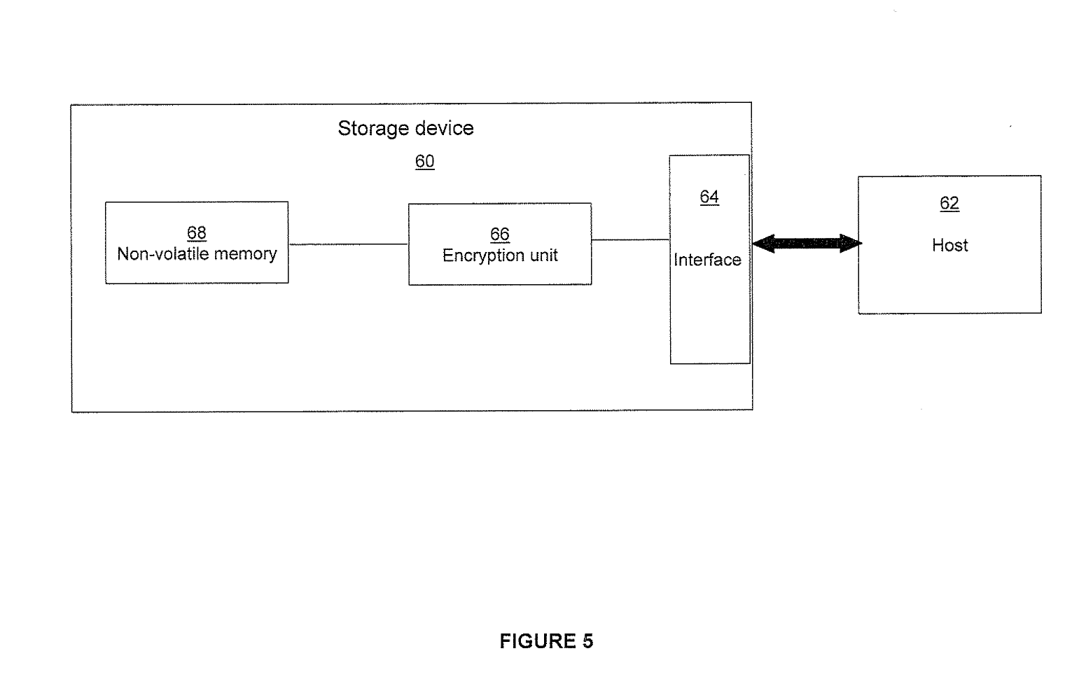

FIG. 5 is an exemplary block diagram of a storage device 60 in communication with a host 62. A public key may be provided to the storage device 60 via an Interface unit 64. Content that is received to storage device 60 is encrypted by an encryption unit 66 and then stored in an encrypted form on a non-volatile memory 68, encryption unit 66 and non-volatile memory 68 operative in a similar manner as their corresponding components of FIG. 3.

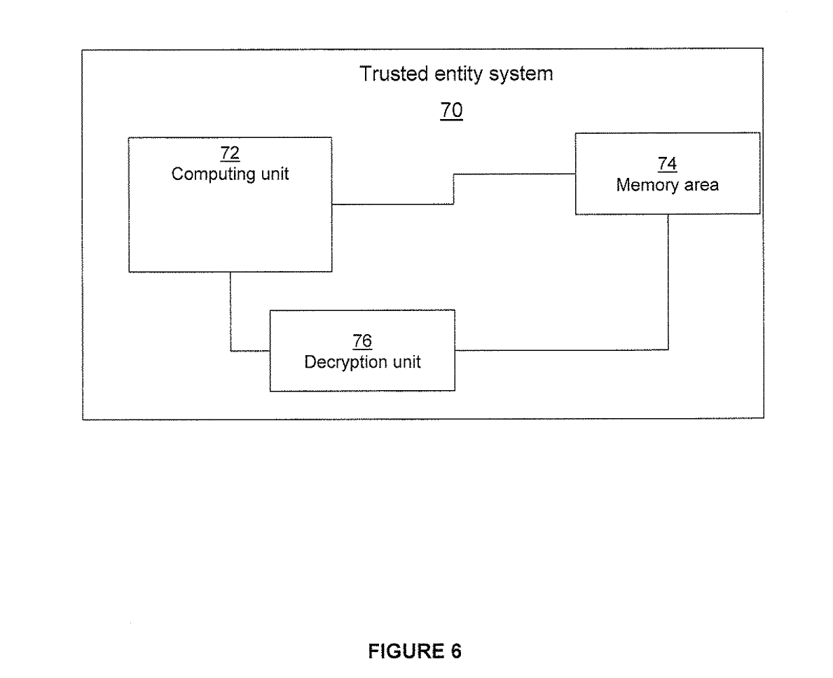

FIG. 6 is an exemplary block diagram of a trusted entity system 70. Trusted entity system 70 may be used by a trusted entity for controlling access (e.g. managing access) to encrypted content that is stored on a storage device, the storage device functioning as a secure device. A trusted entity may be at least one entity other than the owner, dealer, and/or manufacturer of a storage device.

A computing unit 72 is provided to generate a public-private key pair having a public key and a corresponding private key. The private key may be stored on memory area 74 in association with a unique ID of a specific one or more storage device; whereas the public key may be provided to and used by a storage device for encrypting content. Note that the private key is stored on in such a manner that access to the private key is restricted to trusted entity system 70 alone. In other words, the private key must never leave the trusted entity system 70, and is therefore not accessible to any other entity/component/person that is not part of trusted entity system 70. The encrypted content may be decipherable, by trusted entity system 70, only after an indication of authorization for use of the corresponding private key is provided to the trusted entity. The indication of authorization may be an instruction from an authorized entity, including a legal or government entity, to provide reading access to the encrypted content.

A decryption unit 76 may further be provided for decrypting the encrypted content using the corresponding private key. As noted above, the decryption may be performed, by the trusted entity system, only upon receiving the indication of authorization. Typically, decryption unit 76 may first decrypt an encrypted symmetric key using the corresponding private key and conditional on the indication of authorization provided thereto; and only then decrypt the encrypted content using the decrypted symmetric key.

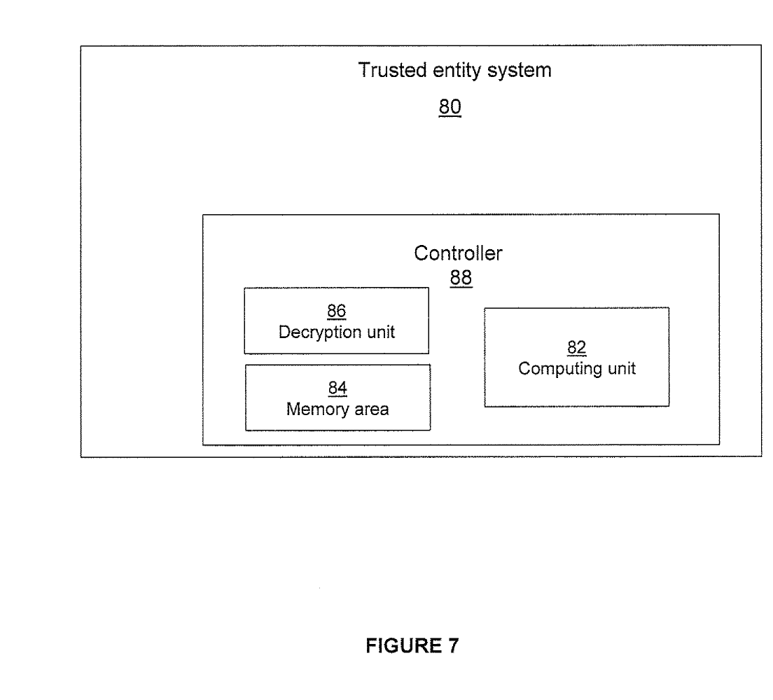

FIG. 7 is another exemplary block diagram of a trusted entity system 80. In the example of FIG. 7 it can be seen that the functionality of computing unit 82, memory area 84; and decryption unit 86 are embedded with a controller 86.

Note that the storing of encrypted content on the storage device should not be construed as limiting, so that regular (non-encrypted) data communicated to the storage device may also be stored on a storage area of the storage device. It should be appreciated that various implementations may use a storage device having more than one partitions, where one or more partitions are used for storing encrypted content and another partition is used for storing regular content.

Having described the various embodiments of a system and method, it is to be understood that the description is not meant as a limitation, since further modifications will now suggest themselves to those skilled in the art, and it is intended to cover such modifications as fall within the scope of the appended claims.

1. A method of preventing unauthorized access to digital content using a storage device, the method comprising:
obtaining from a trusted entity a public key of a public-private key pair; and
encrypting content being received to a storage device, using the public key; and
storing the encrypted content on the storage device,
the content being encrypted using the public key so as to be decipherable by the trusted entity, only by using a corresponding private key of the public-private key pair,
wherein access to the corresponding private key is restricted to a trusted entity alone, and
wherein the encrypted content becomes decipherable by the trusted entity, only after an indication of authorization for use of the corresponding private key is being provided to the trusted entity.

2. The method of claim 1, wherein the indication of authorization is an instruction from an authorized entity, including a legal or government entity, to provide reading access to the encrypted content.

3. The method of claim 1, wherein the trusted entity is at least one entity other than owner, dealer, and/or manufacturer of the storage device.

4. The method of claim 1, further comprising obtaining from a plurality of trusted entities a plurality of public keys of a plurality of corresponding public-private key pairs, to thereby enable the encrypted content to become decipherable by any of the plurality of trusted entities, only after an indication of authorization for use is provided thereto.

5. The method of claim 1, further comprising authorizing the storage device as a secured device.

6. A method of controlling access to encrypted content that is stored on a storage device, the method comprising:
generating a public-private key pair having a public key and a corresponding private key, by a trusted entity; and
providing the public key while restricting access of the corresponding private key to the trusted entity alone, the public key being used by a storage device for encrypting content, such that the encrypted content is stored on the storage device,
wherein the encrypted content becomes decipherable by the trusted entity, only upon an indication of authorization for use of the corresponding private key is being provided to the trusted entity.

7. The method of claim 6, wherein the indication of authorization is an instruction from an authorized entity, including a legal or government entity, to provide reading access to the encrypted content.

8. The method of claim 6, further comprising:
receiving the encrypted content, by the trusted entity; and
decrypting the encrypted content by the trusted entity, only upon receiving the indication for authorization.

9. The method of claim 6, wherein the trusted entity is at least one entity other than owner, dealer, and/or manufacturer of the storage device.

10. The method of claim 6, wherein the public key is used with a plurality of storage devices.

11. A storage device comprising:
an encryption unit operative to encrypt content using a public key of a public-private key pair, the content being encrypted so as to be decipherable by the trusted entity, only by using a corresponding private key of the public-private key pair; and
a non-volatile memory operative to store content which is encrypted,
wherein access to the corresponding private key is restricted to a trusted entity alone, and
wherein the encrypted content becomes decipherable by the trusted entity, only after an indication of authorization for use of the corresponding private key is provided to the trusted entity.

12. The storage device of claim 11 wherein the indication of authorization is an instruction from an authorized entity, including a legal or government entity, to provide reading access to the encrypted content.

13. The storage device of claim 11, wherein the trusted entity is at least one entity other than owner, dealer, and/or manufacturer of the storage device.

14. The storage device of claim 11, wherein the non-volatile memory is a flash memory.

15. The storage device of claim 11, wherein the encrypted content is stored on the non-volatile memory with a plurality of symmetric keys corresponding to a plurality of public keys of a plurality of public-private key pairs.

16. The storage device of claim 15, wherein the encrypted content may become decipherable, by any of a plurality of trusted entities, only after an indication of authorization for use is provided thereto.

17. The storage device of claim 11, further comprising a unique identification that is operative to authorize the storage device as a secure storage device.

18. A trusted entity system comprising:
a computing unit operative to generate a public-private key pair having a public key and a corresponding private key, the public key being used by a storage device for encrypting content; and
a memory area operative to store the corresponding private key, such that access to the corresponding is restricted to the trusted entity alone,
wherein the encrypted content becomes decipherable by the trusted entity, only after an indication for authorization for use of the corresponding private key is being received thereto.

19. The trusted entity system of claim 18, wherein the indication of authorization is an instruction from an authorized entity, including a legal or government entity, to provide reading access to the encrypted content.

20. The trusted entity system of claim 18, wherein the trusted entity is at least one entity other than owner, dealer, and/or manufacturer of the storage device.
